(19) United States
(12) Patent Application Publication
(10) Pub. No.: US 2026/0273701 A1
(43) Pub. Date: Sep. 17, 2026

(54) INTERNAL PLIERS DEVICE

(71) Applicant: Dale Boody, Canon City, CO (US)

(72) Inventor: Dale Boody, Canon City, CO (US)

(21) Appl. No.: 19/419,061

(22) Filed: Dec. 14, 2025

Related U.S. Application Data
(60) Provisional application No. 63/834,361, filed on Mar. 14, 2025.

(51) Int. Cl. B25B 7/12; B25B 7/02; B25B 7/08

(52) U.S. Cl. CPC B25B 7/12; B25B 7/02; B25B 7/08

(57) ABSTRACT

An internal pliers for gripping an inner surface of an object that comprises a pair of opposing handles joined at a first pivot, comprising one right handle and one left handle. The right handle transitioning into a left articulating arm. The left handle transitioning into a right articulating arm. The left articulating arm and the right articulating joined at a second pivot, with the left articulating arm transitioning into a right grip and the right articulating arm transitioning into a left grip. Wherein the opposing handles moving together opens a nose of the pliers by moving the right grip and the left grip apart.

### CROSS REFERENCE TO RELATED APPLICATIONS

This application claims benefit of U.S. Provisional Application 63/834,361 filed Mar. 14, 2025, which is incorporated herein.

### FIELD OF INVENTION

The present invention relates to the field of hand tools, and more specifically to gripping pliers.

### BACKGROUND

This invention falls in the field of devices that grip objects, especially pliers. Pliers are designed to grip the outside surfaces of an object when the ring handles are squeezed. The existing pliers work only if the jaws open wide enough to capture the outside of the object. Also, the jaws have a tendency to scratch finished outside surfaces, smear wet paint, and otherwise mar delicate surfaces. This invention, however, can be used to pick up or move or rotate an object that has a hole or other orifice without the jaws or workers fingers touching the outside surfaces, regardless of whether the part is hot or wet or has a fine outside finish.

### SUMMARY

The innovations described herein present an invention similar to a pair of scissors or pliers, but instead of closing the nose of the pliers and an internal gripping surface onto an object, this pliers instead opens the nose with an exterior gripping surface engaging an object. Thus, this internal pliers is designed for gripping the inside of an object instead of the outside when the ring handles are squeezed. This internal gripping action is especially useful for painted items that need to be rotated for further painting or moved to a drying location. It is also useful for moving weldments and other hot manufactured items to a cooling area or for further processing. It is especially helpful that this invention does not contact or scratch the outside surface and avoids contamination of sterile surfaces.

The pliers can be used to firmly grip an internal surface. This can prevent possible marring of an external surface or facilitating manipulation of a freshly painted item with a wet outer surface but a dry inner surface.

The pliers consist of four main parts-two identical ring handles and two identical jaws. One handle is assembled on the “left” while the opposite identical handle is flipped and assembled on the “right”. The same assembly concept applies to the identical jaws. There are also four identical pivot pins using rivets or shoulder screws with nuts. The pliers shown use shoulder screws with nuts. The pliers can be made larger or smaller and with different shaped jaws for grabbing different objects with different size and shaped holes. Spreading the ring handles apart forces the jaws together for inserting into a hole while squeezing the ring handles together spreads the jaws apart for the gripping action inside the hole. The ringed handles provide better control.

An internal pliers for gripping an inner surface of an object that comprises a pair of opposing handles joined at a first pivot, comprising one right handle and one left handle. The right handle transitioning into a left articulating arm. The left handle transitioning into a right articulating arm. The left articulating arm and the right articulating joined at a second pivot, with the left articulating arm transitioning into a right grip and the right articulating arm transitioning into a left grip. Wherein the opposing handles moving together opens a nose of the pliers by moving the right grip and the left grip apart.

An internal pliers for gripping an inner surface of an object, comprising a pair of opposing handles joined at a first pivot, comprising one right handle and one left handle. The right handle transitioning into a left articulating arm. The left handle transitioning into a right articulating arm. The left articulating arm and the right articulating joined at a second pivot, with the left articulating arm transitioning into a right grip and the right articulating arm transitioning into a left grip. Wherein the opposing handles moving together opens a nose of the pliers by moving the right grip and the left grip apart.

A method for operating an internal pliers for gripping an inner surface of an object, comprising attaching a pair of opposing handles at a first pivot, comprising one right handle and one left handle. Transitioning the right handle into a left articulating arm. Transitioning the left handle into a right articulating arm. Joining the left articulating arm and the right articulating at a second pivot, with the left articulating arm transitioning into a right grip and the right articulating arm transitioning into a left grip. Wherein the opposing handles moving together opens a nose of the pliers by moving the right grip and the left grip apart.

### Advantages

1. Avoids contacting an outer surface subject to easy marring or to facilitate manipulating an object while painting.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 depicts an exemplary a ¾ top view of an internal pliers in a closed position, in an embodiment of the invention;

FIG. 2 depicts an exemplary a top view of an internal pliers in a closed position, in an embodiment of the invention; and

FIG. 3 depicts an exemplary a top view of an internal pliers in an open position, in an embodiment of the invention.

### DETAILED DESCRIPTION OF PREFERRED EMBODIMENTS

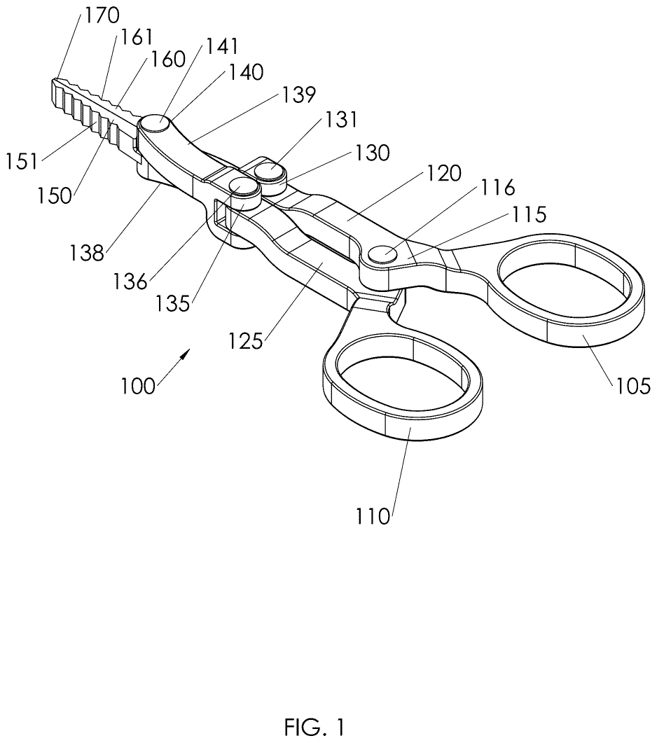

Preferred embodiments of the present invention and their advantages may be understood by referring to FIGS. 1-3, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

The singular includes plural and vice versa. The term “or” is inclusive unless expressly stated otherwise. References to “an embodiment,” “one embodiment,” or similar terminology do not preclude additional embodiments. Features disclosed may be combined, separated, substituted, or reordered unless context dictates otherwise. No particular element, step, or function is essential unless explicitly recited in the claims. Headings are for convenience and do not limit scope.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

As depicted in FIG. 1, internal pliers 100 shows a ¾ top view in a closed position. The internal pliers 100 can comprise a top ring handle 105 and a bottom ring handle 110 opened apart. The two ring handles 105 and 110 are in an open configuration, which configures the internal pliers 100 itself in a closed position. The ring handles 105 and 110 are joined at first pivot 115 which are held in place by a first pivot pin 116. The ring handles 105 and 110 transition into a first arm 120 and a second arm 125 respectively. First arm 120 terminates at a second pivot 130, which is attached to a fourth pivot 140 by third arm 138. The second pivot 130 is secured to third arm 138 by second pivot pin 131. Second arm 125 terminates at a third pivot 135, which is attached to the fourth pivot 140 by fourth arm 139. The third pivot 135 is secured to third arm 139 by third pivot pin 136. Third arm 138 transitions into first grip 150 leading from fourth pivot 140. Fourth arm 139 transitions into second grip 160 from fourth pivot 140. Fourth pivot pin 141 fastens third arm 138 and fourth arm 139 together. The two grips 150 and 160 form nose 170, which as depicted is in a closed configuration. The grips 150 and 160 further include an outer gripping surface 151 and 161 to engage an object's interior surface.

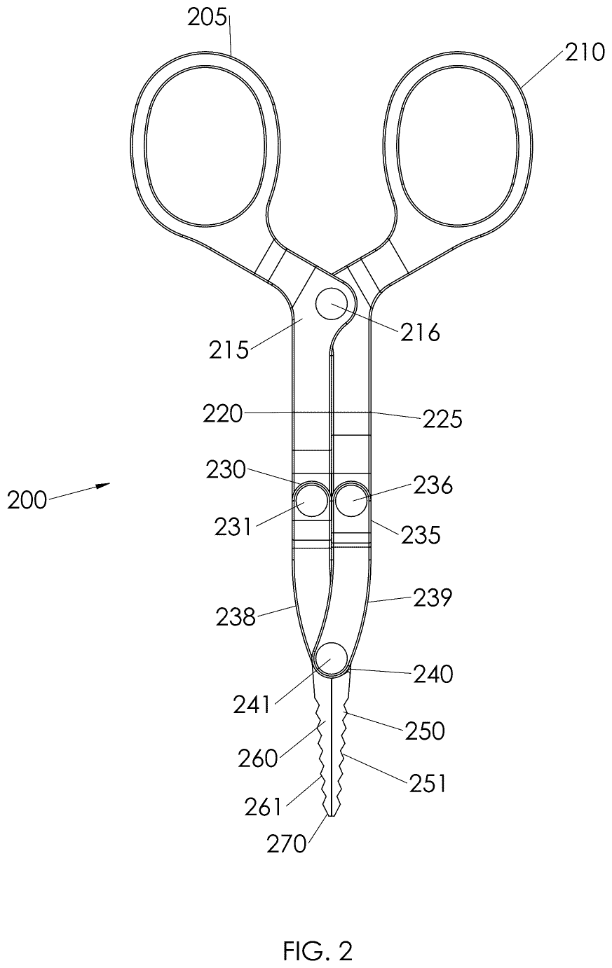

As depicted in FIG. 2, internal pliers 200 shows a top view in a closed position. The internal pliers 200 can comprise a top ring handle 205 and a bottom ring handle 210 opened apart. The two ring handles 205 and 210 are in an open configuration, which configures the internal pliers 200 itself in a closed position. The ring handles 205 and 210 are joined at first pivot 215 which are held in place by a first pivot pin 216. The ring handles 205 and 210 transition into a first arm 220 and a second arm 225 respectively. First arm 220 terminates at a second pivot 230, which is attached to a fourth pivot 240 by third arm 238. The second pivot 230 is secured to third arm 238 by second pivot pin 231. Second arm 225 terminates at a third pivot 235, which is attached to the fourth pivot 240 by fourth arm 239. The third pivot 235 is secured to third arm 238 by third pivot pin 236. Third arm 238 transitions into first grip 250 leading from fourth pivot 240. Fourth arm 239 transitions into second grip 260 from fourth pivot 240. Fourth pivot pin 241 fastens third arm 238 and fourth arm 239 together. The two grips 250 and 260 form nose 270, which as depicted is in a closed configuration. The grips 250 and 260 further include an outer gripping surface 251 and 261 to engage an object's interior surface.

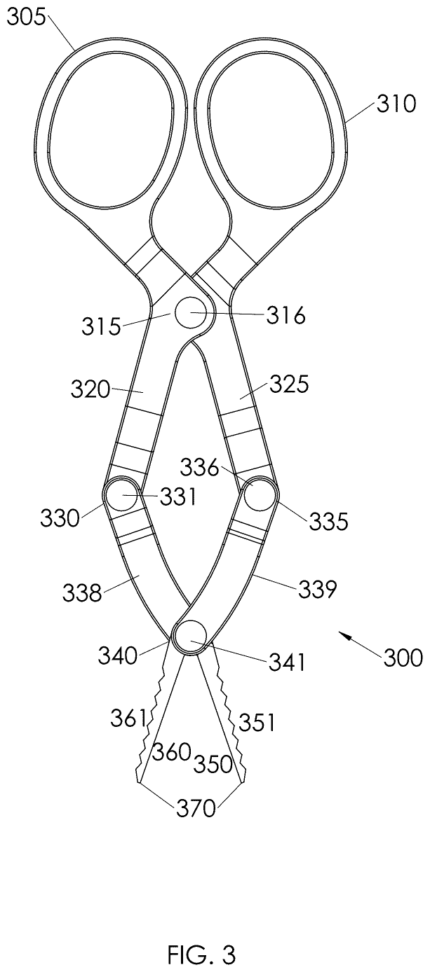

As depicted in FIG. 3, internal pliers 300 shows a top view in an open position. The internal pliers 300 can comprise a top ring handle 305 and a bottom ring handle 310 closed together. The two ring handles 305 and 310 are in an closed configuration, which configures the internal pliers 300 itself in an open position so it can engage an internal surface. The ring handles 305 and 310 are joined at first pivot 315 which are held in place by a first pivot pin 316. The ring handles 305 and 310 transition into a first arm 320 and a second arm 325 respectively. First arm 320 terminates at a second pivot 330, which is attached to a fourth pivot 340 by third arm 338. The second pivot 330 is secured to third arm 338 by second pivot pin 331. Second arm 325 terminates at a third pivot 335, which is attached to the fourth pivot 340 by fourth arm 339. The third pivot 335 is secured to third arm 339 by third pivot pin 336. Third arm 338 transitions into first grip 350 leading from fourth pivot 340. Fourth arm 339 transitions into second grip 360 from fourth pivot 340. Fourth pivot pin 341 fastens third arm 338 and fourth arm 339 together. The two grips 350 and 360 form nose 370, which as depicted is in an open configuration. The grips 350 and 360 further include an outer gripping surface 351 and 361 to engage an object's interior surface.

In operation, when ring handles 105, 110, 205, 210, 305, and 310 are squeezed together, the nose 170, 270, and 370 moves into an open configuration to grip an inner surface. When squeezed together ring handles 105, 110, 205, 210, 305, and 310 cause the first arm 120, 220, and 320 and second arm 125, 225, and 325 to rotate on first pivot 115, 215, and 315 to transition from a closed configuration to an open configuration. This rotation of first pivot 115, 215, and 315 causes second pivot 130, 230, and 330 and third pivot 135, 235, and 335 to rotate third arm 138, 238, 338 and fourth arm 139, 239, and 339 to also rotate on second pivot 130, 230, and 330 and third pivot 135, 235, and 335 as well as the fourth pivot 140, 240, and 340. This rotation causes nose 170, 270, and 370 to open grips 150, 250, 350, 160, 260, and 360 to engage with an inner surface of an object. The opening and closing the internal pliers 100, 200, and 300 can engage an interior surface of an object to grip and manipulate the object. The grips 150, 250, 350, 160, 260, and 360 include an outer gripping surface 151, 161, 251, 261, 351, and 361 to engage an object's interior surface. The gripping surface can further include a soft material such as soft rubber, cloth, neoprene, or similar materials or it can be a hard material such as metal, plastic, or hard leather.

Insofar as the description above and the accompanying drawing disclose any additional subject matter that is not within the scope of the single claim below, the inventions are not dedicated to the public and the right to the one or more applications to claim such additional inventions is reserved.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The foregoing has described an internal pliers device for gripping an object's internal surface that are given for illustration and not for limitation and uses. Thus, the inventions are limited only by the appended claims. Although the inventions have been described in accordance with the embodiments shown, one of ordinary skill in the art will readily recognize that there could be variations to the embodiments and those variations would be within the spirit and scope of the present inventions. Accordingly, many modifications may be made by one of ordinary skill in the art without departing from the spirit and scope of the appended claims.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, are incorporated herein by reference. Aspects of embodiments can be modified, if necessary, to employ the systems, functions, and concepts of the various references to provide yet further embodiments.

In light of the above “Detailed Description,” the Inventors may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventors. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventors contemplate the various aspects in any number of claim forms. Accordingly, the inventors reserve the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the disclosure.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

The foregoing description illustrates embodiments of the invention and is not intended to be exhaustive or to limit the invention to the precise forms disclosed. One skilled in the art will recognize modifications, equivalents, and alternatives in light of the above teaching. The scope of the invention is defined by the appended claims.

I claim:

1. An internal pliers having an open and closed configuration, comprising:
two ring handles that move into an open and closed configurations;
a first pivot connected to a first ring handle and a second ring handle and a second pivot and a third pivot connected to the first pivot, wherein the first ring handle transitions into a first arm and the second ring handle transitions into a second arm;
the second pivot also connects to a third arm and the third pivot also connects to a fourth arm, wherein the third arm and fourth arm are joined by a fourth pivot;
from the fourth pivot, the third arm transitions into a first grip and the fourth arm transitions into a second grip;
wherein the first grip and the second grip move opposite from each other into an open configuration to grip an internal surface when first ring handle and second ring handle are squeezed together.

2. The internal pliers having an open and closed configuration of claim 1, wherein the first grip and the second grip further comprise a gripping surface.

3. The internal pliers having an open and closed configuration of claim 2, wherein the gripping surface further comprises one of a soft material or a hard material.

4. An internal pliers for gripping an inner surface of an object, comprising:
a pair of opposing handles joined at a first pivot, comprising one right handle and one left handle;
the right handle transitioning into a left articulating arm;
the left handle transitioning into a right articulating arm;
the left articulating arm and the right articulating joined at a second pivot, with the left articulating arm transitioning into a right grip and the right articulating arm transitioning into a left grip; and
wherein the opposing handles moving together opens a nose of the pliers by moving the right grip and the left grip apart.

5. The internal pliers of claim 4, further comprising:
the left articulating arm comprises a two-piece arm with a third pivot attaching the two pieces of the left articulating arm together whereby articulation comprises rotation of the third pivot;
the right articulating arm comprises a two-piece structure with a fourth pivot attaching the two pieces of the right articulating arm together whereby articulation comprises rotation of the fourth pivot; and
wherein squeezing the handles together changes the configuration from a closed to opened by moving the right grip and left grip apart.

6. The internal pliers of claim 4, wherein the right grip and the left grip further comprise a right gripping surface and a left gripping surface.

7. The internal pliers of claim 6, wherein the right gripping surface and the left gripping surface further comprises one of a soft material or a hard material.

8. The internal pliers of claim 4, wherein the right handle and the left handle further comprise rings.

9. A method for operating an internal pliers for gripping an inner surface of an object, comprising:
attaching a pair of opposing handles at a first pivot, comprising one right handle and one left handle;
transitioning the right handle into a left articulating arm;
transitioning the left handle into a right articulating arm;
joining the left articulating arm and the right articulating at a second pivot, with the left articulating arm transitioning into a right grip and the right articulating arm transitioning into a left grip; and
wherein the opposing handles moving together opens a nose of the pliers by moving the right grip and the left grip apart.

10. The method of claim 9, further comprising:
providing a two-piece left articulating arm attached together by a third pivot attaching the two pieces of the left articulating arm whereby articulation comprises rotation of the third pivot;
providing a two-piece right articulating arm attached together by a fourth pivot attaching the two pieces of the right articulating arm whereby articulation comprises rotation of the fourth pivot; and
wherein squeezing the handles together changes the configuration from closed to opened by moving the right grip and left grip apart.

11. The method of claim 9, wherein the right grip and the left grip further comprise a right gripping surface and a left gripping surface.

12. The method of claim 11, wherein the right gripping surface and the left gripping surface further comprises a soft material.

13. The method of claim 11, wherein the right gripping surface and the left gripping surface further comprises a hard material.

14. The method of claim 9, wherein the right handle and the left handle further comprise a pair of ringed handles.
